(19) United States
(12) Patent Application Publication
(10) Pub. No.: US 2025/0218621 A1
(43) Pub. Date: Jul. 3, 2025

(54) MULTI-CORE CABLE

(71) Applicants: SUMITOMO ELECTRIC INDUSTRIES, LTD., Osaka (JP); Sumitomo Wiring Systems, Ltd., Mie (JP)

(72) Inventors: Shunya TASHIRO, Tochigi (JP); Takumi OOSHIMA, Tochigi (JP); Kenji ITO, Mie (JP); Takahiro MURATA, Mie (JP)

(21) Appl. No.: 18/953,566

(22) Filed: Nov. 20, 2024

(30) Foreign Application Priority Data
Dec. 28, 2023 (JP) 2023-223340

(51) Int. Cl. H01B 7/282; H01B 7/18; H01B 11/04

(52) U.S. Cl. CPC H01B 7/2825; H01B 7/1875; H01B 11/04

(57) ABSTRACT

A multi-core cable has a core including a plurality of sheathed electrical wires twisted together, a tape member disposed outside the core and wound spirally around the core along a longitudinal direction of the core, and an outer sheath disposed outside the tape member. The tape member has a water absorption amount of 4 mm/10 minutes or less. The water absorption amount is a length of a region in which absorbed water is distributed in a state where one end of the multi-core cable along a longitudinal direction of the tape member is immersed in water.

### CROSS-REFERENCE TO RELATED APPLICATIONS

This application is based upon and claims priority to Japanese Patent Application No. 2023-223340, filed on Dec. 28, 2023, the entire contents of which are incorporated herein by reference.

### TECHNICAL FIELD

The present disclosure relates to multi-core cables.

### BACKGROUND

As an example, Japanese Laid-Open Patent Publication No. 2014-220043 proposes an electrical insulation cable having a core electrical wire, a sheath layer formed to cover the core electrical wire, and a tape member disposed between the core electrical wire and the sheath layer in a state wound around the core electrical wire.

### SUMMARY

According to one aspect of the embodiments of the present disclosure, a multi-core cable has a core including a plurality of sheathed electrical wires twisted together; a tape member disposed outside the core and wound spirally around the core along a longitudinal direction of the core; and an outer sheath disposed outside the tape member, wherein the tape member has a water absorption amount of 4 mm/10 minutes or less, and the water absorption amount is a length of a region in which absorbed water is distributed in a state where one end of the multi-core cable along a longitudinal direction of the tape member is immersed in water.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a cross sectional view illustrating a multi-core cable according to a first example of an embodiment of the present disclosure along a plane perpendicular to a longitudinal direction of the multi-core cable;

FIG. 2 is a cross sectional view illustrating the multi-core cable according to a second example of the embodiment of the present disclosure along the plane perpendicular to the longitudinal direction of the multi-core cable; and

FIG. 3 is a diagram for explaining an evaluation method of water absorption amount.

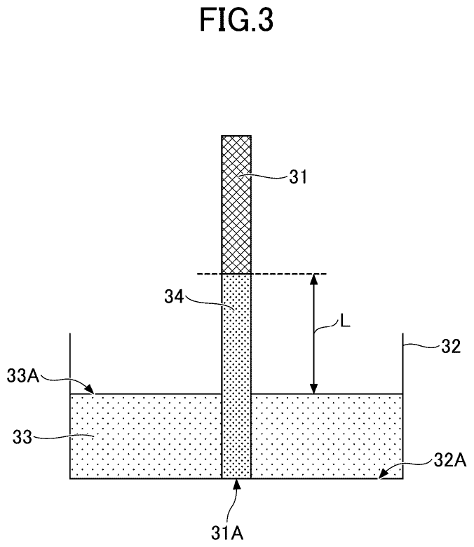

### DETAILED DESCRIPTION

Depending on an installation environment of the multi-core cable, water may enter from a first end of the multi-core cable along a longitudinal direction thereof, and the water may reach a second end of the multi-core cable opposite to the first end. Water causes deterioration or failure of an electrical device that is connected to the second end of the multi-core cable, and for this reason, there are demands to prevent water from entering inside the multi-core cable.

Accordingly, one aspect of embodiments of the present disclosure provides a multi-core cable capable of preventing water from entering inside the multi-core cable.

A description will hereinafter be given of embodiments of the present disclosure with reference to the drawings.

### [Description of Embodiments of Present Disclosure]

The embodiments of the present disclosure will be described in the following. In the following description, constituent elements that are substantially the same will be designated by the same reference numerals, and a redundant description thereof will be omitted.

[1] A multi-core cable according to one aspect of the present disclosure includes:
a core including a plurality of sheathed electrical wires twisted together;
a tape member disposed outside the core and wound spirally around the core along a longitudinal direction of the core; and
an outer sheath disposed outside the tape member, wherein:
the tape member has a water absorption amount of 4 mm/10 minutes or less, and
the water absorption amount is a length of a region in which absorbed water is distributed in a state where one end of the multi-core cable along a longitudinal direction of the tape member is immersed in water.

By setting the water absorption amount of the tape member to 4 mm/10 minutes or less, the tape member can be made less water absorbent, and it is possible to prevent water from running along the tape member and entering inside the multi-core cable. Hence, it is possible to provide a multi-core cable capable of preventing water from entering inside the multi-core cable.

[2] In the multi-core cable according to [1],
the core may include two first electrical wires, and a twisted pair wire that are twisted together,
the twisted pair wire may include two second electrical wires that are twisted together, and
an outer diameter of each of the two second electrical wires may be smaller than an outer diameter of the each of the two first electrical wires.

By configuring the twisted pair wire by twisting together the two sheathed electrical wires having the same configuration, signals transmitted through the sheathed electrical wires are less affected by noise.

When the outer diameter of each of the two second electrical wires is smaller than an outer diameter of the each of the two first electrical wires, an outer diameter of the twisted pair wire can be made closer to the outer diameter of the first electrical wire. For this reason, an outer shape of the multi-core cable in a cross section perpendicular to the longitudinal direction thereof can be made closer to a circular shape.

### [Details of Embodiments of Present Disclosure]

Specific examples of the multi-core cable according to an embodiment of the present disclosure (hereinafter referred to as “the present embodiment”) will be described below with reference to the drawings. The present invention is not limited to these examples, and various omissions, substitutions, variations, and modifications may be made without departing from the scope of the subject matter of the present invention.

In the present specification, terms “first”, “second”, or the like may be added to names of constituent elements, such as a first electrical wire, a second electrical wire, a first conductor, a second conductor, a first insulator, and a second insulator. The terms “first”, “second”, or the like are used only for the purpose of distinguishing the respective constituent elements and preventing confusion in the description, and do not represent an order of arrangement, a priority, or the like. Accordingly, in cases where the constituent elements are referred to collectively or there is no particular possibility of confusion among the constituent elements, the terms such as “electrical wire”, “conductor”, and “insulator” may be used.

### [Multi-Core Cable]

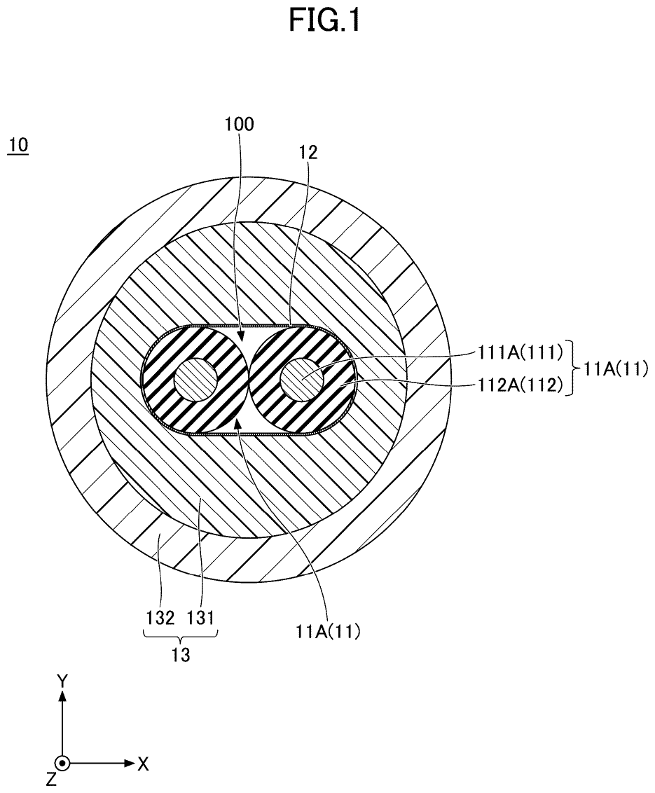

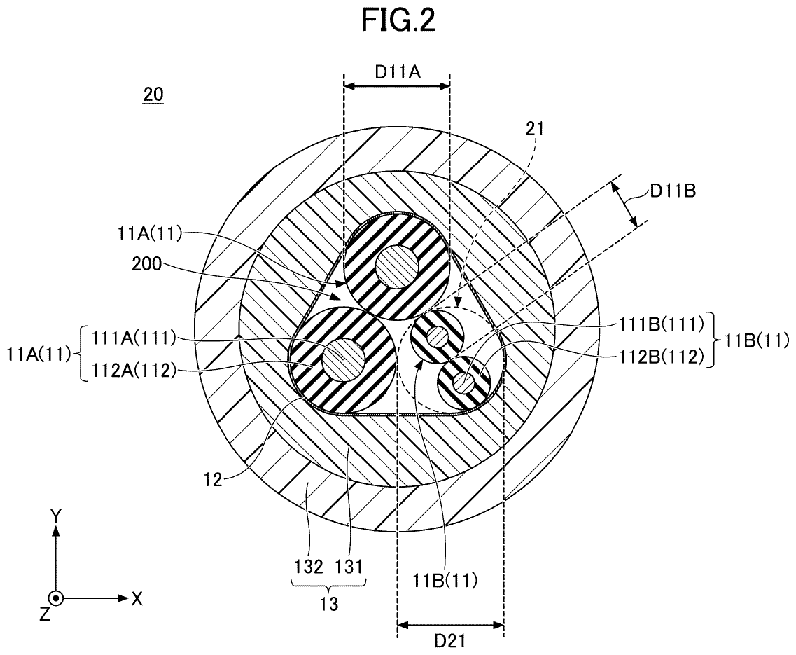

FIG. 1 and FIG. 2 illustrate a configuration example of a cross section perpendicular to a longitudinal direction of a multi-core cable according to first and second examples of the present embodiment, respectively. In FIG. 1 and FIG. 2, a Z-axis corresponds to an axis along the longitudinal direction of a multi-core cable 10, and an XY-plane is a plane perpendicular to the longitudinal direction of the multi-core cable 10. In FIG. 2, the Z-axis corresponds to the axis along the longitudinal direction of a multi-core cable 20, and the XY-plane is a plane perpendicular to the longitudinal direction of the multi-core cable 20.

The multi-core cable 20 illustrated in FIG. 2 is the same as the multi-core cable 10 illustrated in FIG. 1, except for a configuration of a plurality of sheathed electrical wires. For this reason, a description will be made mainly with reference to FIG. 1, and a description will be made with reference to FIG. 2, as required.

As illustrated in FIG. 1, the multi-core cable 10 of the present embodiment includes a core 100 including a plurality of sheathed electrical wires 11 twisted together, a tape member 12 disposed outside the core 100 and wound spirally around the core 100 along a longitudinal direction of the core 100, and an outer sheath 13 disposed outside the tape member 12.

Each constituent element included in the multi-core cable 10 of the present embodiment will be described.

### (1) Core:

### (1-1) Constituent Elements of Core:

The core 100 includes the plurality of sheathed electrical wires 11.

### (1-1-1) Sheathed Electrical Wires:

The configuration and the number of the sheathed electrical wires 11 included in the core 100 are not particularly limited, and can be selected according to a device or the like to be connected to the multi-core cable 10.

The plurality of sheathed electrical wires 11 included in the multi-core cable 10 can be twisted to form the core 100. The multi-core cable 10 may include a coaxial wire, a drain wire, or the like, as required, in addition to the sheathed electrical wires 11 described below.

The core 100 of the multi-core cable 10 illustrated in FIG. 1 has a configuration in which two first electrical wires 11A are twisted together.

A core 200 of the multi-core cable 20 illustrated in FIG. 2 has a configuration in which two first electrical wires 11A and a twisted pair wire 21 are twisted together.

The sheathed electrical wire 11 and the twisted pair wire 21 will be described below in this order.

### (A) Sheathed Electrical Wires:

The sheathed electrical wire 11 may include a conductor 111, and an insulator 112 covering an outer surface of the conductor 111.

A first electrical wire 11A illustrated in FIG. 1 and FIG. 2 is an example of the sheathed electrical wire 11. The first electrical wire 11A may include a first conductor 111A, and a first insulator 112A which covers an outer surface of the first conductor 111A.

A second electrical wire 11B illustrated in FIG. 2 is an example of the sheathed electrical wire 11. The second electrical wire 11B may include a second conductor 111B, and a second insulator 112B which covers an outer surface of the second conductor 111B.

Configuration examples of constituent elements of the sheathed electrical wire 11 will be described.

### (A-1) Conductor:

The conductor 111 may include a single conductor element wire (single conductor strand) or a plurality of conductor element wires (plurality of conductor strands). In a case where the conductor 111 includes the plurality of conductor element wires, the plurality of conductor element wires may be twisted together. Hence, in a case where the conductor 111 includes the plurality of conductor element wires, the conductor 111 may include the plurality of conductor element wires twisted together (that is, the conductor 111 may be a twisted wire or strand composed of the plurality of conductor element wires).

A material used for the conductor 111 is not particularly limited, and may be copper, copper alloy, or the like, for example. Soft copper or hard copper may be used as the copper. The material used for the conductor 111 may be plated with tin or silver.

### (A-2) Insulator:

A material used for the insulator 112 is not particularly limited, and may include a resin material or the like, for example.

Examples of the resin material used for the insulator 112 include one or more kinds of materials selected from polyolefin resins, polyolefin-based copolymers, fluororesins, polyester resins, or the like, for example. Examples of the polyolefin resins include polyethylene, polypropylene, and polymethylpentene, for example. Examples of the polyolefin-based copolymers include ethylene vinyl acetate, ethylene ethyl acrylate, ethylene methyl acrylate copolymer, or the like, for example. Examples of the fluororesins include polytetrafluoroethylene (PTFE), tetrafluoroethylene-perfluoroalkyl vinyl ether copolymer (PFA), tetrafluoroethylene-hexafluoropropylene copolymer (FEP), ethylene-tetrafluoroethylene copolymer (ETFE), or the like, for example. Examples of the polyester resins include polyethylene terephthalate (PET) or the like, for example. The resin material included in the insulator 112 may be crosslinked or not crosslinked.

The insulator 112 may be formed solely of the resin material described above. Alternatively, the insulator 112 may include one or more additives selected from a flame retardant, a flame retardant aid, an antioxidant, a lubricant, a coloring agent, a reflective agent, a masking agent, a processing stabilizer, a plasticizer, or the like in addition to the resin material.

The materials and configurations used for the conductor 111 and the insulator 112 may be different between the first electrical wire 11A and the second electrical wire 11B included in the multi-core cable 20 illustrated in FIG. 2. In the multi-core cable 20 illustrated in FIG. 2, an outer diameter D11B of the second electrical wire 11B may be smaller than an outer diameter D11A of the first electrical wire 11A.

By making the outer diameter D11B of the second electrical wire 11B smaller than the outer diameter D11A of the first electrical wire 11A, an outer diameter D21 of the twisted pair wire 21 can be made closer to the outer diameter D11A of the first electrical wire 11A. For this reason, the outer shape of the multi-core cable 20 in the cross section perpendicular to the longitudinal direction thereof can be made closer to a circular shape. When the outer diameter D11B of the second electrical wire 11B is approximately one-half the outer diameter D11A of the first electrical wire 11A, the outer shape of the multi-core cable 20 in the cross section perpendicular to the longitudinal direction can be made particularly closer to the circular shape.

For example, the outer diameter D21 of the twisted pair wire 21 may approximately coincide with the outer diameter D11A of each of the two first electrical wires 11A. The outer diameter D21 of the twisted pair wire 21 approximately coincides with the outer diameter D11A of each of the two first electrical wires 11A in the case where the outer diameter D11B of each of the second electrical wires 11B is approximately one-half the outer diameter D11A of each of the two first electrical wires 11A, including a manufacturing error (or a manufacturing variation) in a range of −10%<=(D11A−2*D11B)/D11A<=10%, for example.

### (B) Twisted Pair Wire:

Similar to the multi-core cable 20 illustrated in FIG. 2, some of the sheathed electrical wires 11 included in the core 200 may be twisted in advance to form a twisted pair wire or the like, for example. In the twisted pair wire 21 included in the multi-core cable 20 illustrated in FIG. 2, two second electrical wires 11B are twisted together.

By configuring the twisted pair wire 21 by twisting together the two sheathed electrical wires 11 having the same configuration, signals transmitted through the sheathed electrical wires 11 are less affected by noise.

### (2) Tape Member:

The tape member 12 may be wound spirally around the core 100 along the longitudinal direction of the core 100.

Because the multi-core cable 10 has the tape member 12, it is easy to remove the outer sheath from the multi-core cable 10 and extract the core 100.

The present inventors studied the cause of water entering from a first end of the multi-core cable and reaching a second end of the multi-core cable opposite to the first end.

In a conventional multi-core cable, a tape-like member, referred to as a wrapping or the like, is disposed between a core and an outer sheath. Hence, the present inventors studied infiltration of water into the multi-core cable due to the tape-like member.

A length of a region in which absorbed water is distributed in a state where one end of the multi-core cable 10 along a longitudinal direction of the tape member 12 is immersed in water for 10 minutes will be referred to as “a water absorption amount of the tape member”.

As a result of the studies conducted by the present inventors, it was found that the tape member 12 can be made less water absorbent by setting the water absorption amount of the tape member 12 to 4 mm/10 minutes or less. Further, it is possible to prevent water from running along the tape member 12 and entering inside the multi-core cable 10, and provide the multi-core cable 10 capable of preventing water from entering inside the multi-core cable 10. The water absorption amount of the tape member 12 may be 3.5 mm/10 minutes or less.

The smaller the water absorption amount of the tape member, the more preferable. However, if the tape member does not absorb water at all, it may be difficult to remove the outer sheath when extracting the core. For this reason, the water absorption amount of the tape member may be 0.1 mm/10 minutes or more.

A material used for the tape member 12 is not particularly limited, as long as the water absorption amount of the tape member 12 falls within the range described above. For example, a viscose-containing paper tape can be used for the tape member 12. A nonwoven fabric, a woven or knitted fabric of fibers, or a thin film of a resin can also be used for the tape member 12, as long as the water absorption amount falls within the range described above. The range described above is 0.1 mm/10 minutes or more and 4 mm/10 minutes or less, and more preferably 0.1 mm/10 minutes or more and 3.5 mm/10 minutes or less, for example.

A winding direction of the tape member 12 may be the same as a twisting direction of the sheathed electrical wires 11 included in the core 100, or may be opposite to the twisting direction of the sheathed electrical wires 11 included in the core 100.

### (3) Outer Sheath:

The outer sheath 13 can be disposed outside the tape member 12.

Because the multi-core cable 10 includes the outer sheath 13, the sheathed electrical wires 11 included in the core 100 can be protected to improve durability thereof.

### (Resin Material)

The outer sheath 13 may include a resin material. The resin material is not particularly limited, and examples of the resin include polyolefin-based resins, such as polyethylene, polypropylene, ethylene-vinyl acetate copolymer (EVA), or the like, a polyurethane elastomer (polyurethane resin), a polyester elastomer, and a composition composed of a mixture of at least two kinds of materials described above, for example.

As illustrated in FIG. 1, the outer sheath 13 may include a plurality of layers, such as a first outer sheath 131 and a second outer sheath 132 in this order from a position closer to the core 100. The outer sheath 13 is not limited to the two-layer configuration illustrated in FIG. 1, and may be have a single-layer configuration or a multi-layer configuration including three or more layers. The first outer sheath 131 and the second outer sheath 132 may be formed of different materials, or formed of the same material.

The resin material used for the first outer sheath 131 may include one or more kinds of resins selected from polyurethane resin and polyolefin-based resins, for example.

The resin material used for the second outer sheath 132 may include a polyurethane resin having an excellent abrasion resistance. Because the second outer sheath 132 is disposed so as to include the outer surface of the multi-core cable 10, the durability of the multi-core cable 10 can be improved by including a polyurethane resin as the resin material used for the second outer sheath 132.

The resin material used for the outer sheath 13 may be crosslinked or may not be crosslinked.

### (Additives)

The outer sheath 13 may include one or more additives selected from a flame retardant, an antioxidant, a deterioration inhibitor, an acid acceptor, a coloring agent, a crosslinking agent, a crosslinking aid, a processing aid, a filler, a lubricant, or the like, in addition to the resin material.

### Experimental Examples

Experimental examples of the present disclosure will be described below with reference to specific examples, but the present invention is not limited to these experimental examples.

### (Evaluation Method)

First, an evaluation method for evaluating a multi-core cable manufactured in the following experimental examples will be described.

### (1) Water Absorption Amount of Tape Member:

A test piece 31 of a tape member, used when manufacturing the multi-core cable, was set so that an end 31A of the tape member along a longitudinal direction thereof makes contact with a bottom surface 32A of a water tank 32 filled with water 33 and the test piece 31 of the tape member is in a state stretched along the longitudinal direction thereof. After a test time of 10 minutes elapsed from a time when the test piece 31 of the tape member was set as described above, a length L of a region 34 in which water absorbed by the test piece 31 of the tape member is distributed, from a water surface 33A, was measured. The measured length L was determined as a water absorption amount of the test piece 31 of the tape member.

### (2) Water Absorption Amount of Multi-Core Cable:

A water absorption amount of the multi-core cable manufactured in each of the experimental examples was evaluated under the same conditions as the test piece 31 of the tape member, except that a test piece 31 of the multi-core cable manufactured in each of the experimental examples was used in place of the test piece 31 of the tape member and the test time was changed.

After a test time of 3 hours elapsed from a time when the test piece 31 of the multi-core cable was set in the water tank 32 in place of the test piece 31 of the tape member, test piece 31 of the multi-core cable was taken out of the water tank 32 and the outer sheath of the test piece 31 of the multi-core cable was removed. Next, a length L of a region 34 in which water absorbed by the test piece 31 of the multi-core cable is distributed, from the water surface 33A, was measured.

### (Experimental Conditions and Results)

The multi-core cable manufactured in each of the experimental examples will be described below.

Multi-core cables according to the following experimental examples EE1 through EE4 were manufactured. The experimental examples EE1, EE2, and EE3 are exemplary implementations, and the experimental example EE4 is a comparative example.

### Experimental Examples EE1 through EE4

The multi-core cable 20 having the cross section perpendicular to the longitudinal direction with the configuration illustrated in FIG. 2 was manufactured, and the water absorption amount of the multi-core cable 20 was evaluated. The outer diameter D11B of the second electrical wire 11B is smaller than the outer diameter D11A of the first electrical wire 11A.

A viscose-containing paper tape was used as the tape member of the multi-core cable 20. In the experimental examples EE1 through EE3, the viscose-containing paper tapes having different viscose contents were used. The experimental example EE4 used a viscose-free paper tape containing no viscose.

The water absorption amount of the tape member used to manufacture the multi-core cable, and the water absorption amount of the manufactured multi-core cable, were evaluated.

Evaluation results are illustrated in Table 1. When testing the multi-core cable, the water absorption amount that is 200 mm/3 hours or more was determined as being too large and incapable of preventing the water from entering inside the multi-core cable.

TABLE 1

| | Water absorption amount | |
|---|---|---|
| | Tape member | Multi-core cable |
| | (mm/10 minutes) | (mm/3 hours) |
| Experimental | 1 | 140 |
| example EE1 | | |
| Experimental | 2 | 160 |
| example EE2 | | |
| Experimental | 4 | 170 |
| example EE3 | | |
| Experimental | 10.5 | 210 |
| example EE4 | | |

According to one aspect of embodiments of the present disclosure, it is possible to provide a multi-core cable capable of preventing water from entering inside the multi-core cable.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A multi-core cable comprising:
a core including a plurality of sheathed electrical wires twisted together;
a tape member disposed outside the core and wound spirally around the core along a longitudinal direction of the core; and
an outer sheath disposed outside the tape member, wherein:
the tape member has a water absorption amount of 4 mm/10 minutes or less, and
the water absorption amount is a length of a region in which absorbed water is distributed in a state where one end of the multi-core cable along a longitudinal direction of the tape member is immersed in water.

2. The multi-core cable as claimed in claim 1, wherein:
the core includes two first electrical wires, and a twisted pair wire that are twisted together,
the twisted pair wire includes two second electrical wires that are twisted together, and
an outer diameter of each of the two second electrical wires is smaller than an outer diameter of the each of the two first electrical wires.

3. The multi-core cable as claimed in claim 2, wherein:
each of the two first electrical wires includes a first conductor and a first insulator covering an outer surface of the first conductor, and
each of the two second electrical wires includes a second conductor and a second insulator covering an outer surface of the second conductor.

4. The multi-core cable as claimed in claim 2, wherein an outer diameter of the twisted pair wire approximately coincides with the outer diameter of each of the two first electrical wires.

5. The multi-core cable as claimed in claim 1, wherein a winding direction of the tape member coincides with a twisting direction of the plurality of sheathed electrical wires included in the core.

6. The multi-core cable as claimed in claim 1, wherein a winding direction of the tape member is opposite to a twisting direction of the plurality of sheathed electrical wires included in the core.
